(19) United States
(12) Patent Application Publication
(10) Pub. No.: US 2013/0164089 A1
(43) Pub. Date: Jun. 27, 2013

(54) DRILLING TOOL

(71) Applicant: GUEHRING OHG, Albstadt (DE)

(72) Inventor: Lutfi BOZKURT, Winterlingen (DE)

(73) Assignee: GUEHRING OHG, Albstadt (DE)

(21) Appl. No.: 13/689,180

(22) Filed: Nov. 29, 2012

Related U.S. Application Data
(63) Continuation of application No. PCT/DE2011/001172, filed on May 30, 2011.

(30) Foreign Application Priority Data
May 31, 2010 (DE) 102010017163

(51) Int. Cl. B23B 51/02; B23B 51/00

(52) U.S. Cl. CPC B23B 51/02; B23B 51/00
USPC 408/200; 408/229; 408/230; 408/215

(57) ABSTRACT

The invention relates to a drilling tool comprising a clamping shaft and cutting element contiguous with said clamping shaft. The cutting element comprises at least one flute having a flute surface that has a concave cross-section. The at least one flute has a cut-in section in the chip-forming zone adjacent to the main cutting edge in the area of the flute front and/or the back segment to enlarge the flute cross-section.

### FIELD OF THE INVENTION

The invention relates to a drilling tool according to the preamble of claim 1.

### BACKGROUND OF THE INVENTION

Generic drilling tools, for example of the kind known from DE 202005000994 U1, DE 3319718 A1 or DE 102008023856 A1, have a clamping shaft for clamping the drilling tool in a jaw chuck and a cutting element contiguous with the clamping shaft, which exhibits one or more straight or spiral-grooved flutes, i.e., flutes that run linearly or helically around the tool axis. The flutes that are cut into the cutting element by means of a corresponding profile or form grinding wheel usually exhibit a concave flute surface, whose cross section can be curved or angled. Aside from custom manufactured items for special applications, generic drilling tools are distinguished by the fact that the flute cross section remains the same from the chip-forming zone adjacent to the main cutting edge up to the outlet on the clamping shaft side. The flute cross section is critical to ensure a good chip discharge in the direction of the clamping shaft.

### SUMMARY OF THE INVENTION

However, too large a flute cross section detracts from tool stability. The chip-forming zone begins at the main cutting edge, and is thus defined by the cutting wedge geometry of the main cutting edge. Given a positive front rake angle, the cutting wedge forms a sharp main cutting edge, which tends to break off, depending on the material to be machined. Therefore, a small or even negative front rake angle is often selected to increase the stability of the main cutting edge. On the other hand, a positive front rake angle allows the chips to more easily glide over the cutting wedge.

Proceeding from the above, the object of the invention is to provide a drilling tool distinguished by an improved chip removal and a long service life.

This object is achieved by a drilling tool with the features in claim 1. Advantageous further developments are the subject of dependent claims.

The drilling tool according to the invention has a clamping shaft and a cutting element contiguous with the clamping shaft, which exhibits at least one flute that runs preferably helically around the tool axis and has a flute surface with a concave, in particular concavely curved, cross section. In the chip-forming zone adjacent to the main cutting edge of the drilling tool, the flute is cut into the area of the flute front and/or back segment to enlarge the flute cross section.

The drilling tool according to the invention can be single- or multiple-edged, with one or more flutes running preferably helically around the tool axis. The at least one flute is cut into the area of the chip-forming zone, i.e., in the area pivotal to chip formation, which is contiguous with the main cutting edge. Therefore, the cut-in is independent of any additionally present core or chisel edge point thinning of the kind known for drilling tools from DIN 1412. The potentially present additional core or chisel edge point thinning lies outside the chip-forming zone, while the cut-in according to the invention lies at least partially within the chip-forming zone, i.e., in the area of the flute pivotal to chip formation. The cut-in can be relatively easily actuated by means of a suitable form grinding wheel dipped into the flute, and initially enlarges the cross section of the flute in the area of the chip-forming zone. The cut-in, whose cross section is defined via the profile of the form grinding wheel and its advancing or delivery motion relative to the drilling tool, causes material to be removed in the area of the chip-forming zone. The cross section of the flute is thus enlarged in the area of the cut-in. As a consequence, the chip formed at the main cutting edge has available to it in the area of the chip-forming zone a chip space with an enlarged cross section, in which the chip can be discharged in the direction of the clamping shaft. This counteracts an accumulation of chips frequently observed in conventional drilling tools. Chip formation at the main cutting edge is improved as a result. In addition, the cut-in yields a region encompassing the flute front and/or back segment that ideally has a cross section curved more strongly than the cross section of the flute outside the cut-in. As a result, the chip in the area of the cut-in becomes more strongly curved than in the area of the flute outside the cut-in. The stronger chip curvature helps cause the chip to break up relatively early, so that short chip fragments are present at the outlet of the cut-in or chip-forming zone, which then can be smoothly discharged via the area of the flute contiguous with the cut-in.

The discharge of chips or chip fragments in the direction of the clamping shaft can be improved even further by feeding coolant/lubricant into the borehole. To this end, the drilling tool can be equipped in a known manner with an internal coolant/lubricant supply system.

Since the cut-in is limited to the area of the chip-forming zone, i.e., at least essentially does not encompass the core of the drilling tool, the cross section of the drilling tool is not weakened to an inordinate extent, viewed overall. In particular, the cut-in can be designed in such a way as to only extend over a relatively short axial length of the cutting element, which advantageously is defined as a function of the tool diameter. For example, the axial length over which the cut-in extends measures 0.5 to 1.5 times the tool diameter. As a result, the core cross section of the drilling tool can be at least essentially retained despite the cut-in of the flute, thereby making it possible to ensure a long tool service life. By restricting the axial length of extension by the cut-in to the chip-forming zone, the flute cross section can be optimized after the fact to suit the respective requirements even in a drilling tool that has already been completely ground, without it being necessary to cost-intensively shape the cross section of the drilling tool.

In particular, the cut-in makes it possible not just to enlarge the flute cross section, but also to advantageously change the position and/or progression of the main cutting edge. In the case of a conventional drilling tool in which the main cutting edge normally lies in a plane situated a prescribed distance in front of an axial plane of the drilling tool, for example, the cut-in can be configured in such a way as to form a corrected main cutting edge at least essentially lying in an axial plane of the drilling tool, while retaining the nose. Furthermore, the cut-in of the flute can be configured in such a way that the chip-forming zone incorporates chip guiding stages, which break up the chips and guide them in the direction of the flute continuing toward the shaft section.

In addition, the cut-in according to the invention provides an opportunity, in the area of the chip-forming zone adjacent to the main cutting edge, to correct the front rake angle that helps form the main cutting edge or the cutting wedge geometry that defines the main cutting edge proceeding from the nose toward the tool axis without using one of the special geometries known in the art. For example, cutting the flute into the chip-forming zone makes it possible to correct the cutting wedge geometry at least over a longitudinal section of the main cutting edge in such a way that the wedge angle of the cutting wedge defining the main cutting edge increases along the main cutting edge in the direction of the tool axis, or the front rake angle between the flute front (cutting face) and tool axis tapers in the direction of the tool axis.

In a drilling tool according to the invention, the cut-in preferably lies radially inside the nose between the main and secondary cutting edge. This configuration ensures that the cut-in does not encompass the nose, but rather extends in a radial direction from a position inside the nose in the direction of the tool axis. Since the nose is retained, the cut-in can also be introduced after the fact on a conventional tool.

The cut-in preferably also gradually runs out radially inside the secondary cutting edge. This configuration retains the secondary cutting edge, and hence a heel formed along the secondary cutting edge. As a result, the cut-in extends in a radial direction completely inside the secondary cutting edge.

The drilling tool according to the invention can be designed as a single piece out of a suitable material, e.g., solid carbide. However, in a preferred further development, the drilling tool according to the invention is comprised of a base body fitted with one or more plate-like cutting inserts, specifically in such a way that the main and secondary cutting edges each (at least partially) are formed on a plate-like cutting insert arranged in a frontally and circumferentially open receiving pocket worked into the flute. Therefore, the cutting insert helps to form the main and secondary cutting edges, at least in the area of the nose.

For example, by guiding the form grinding wheel in a linear advancing or delivery motion relative to the drilling tool, a corresponding form grinding wheel can be used to fashion the cut-in such a way as to form a plane surface in a flute having a flute surface with a concavely curved cross section. The plane surface can be relatively easily machined to create the receiving pocket for the plate-like cutting insert. The plate-like cutting insert can be comprised of a highly wear resistant material, e.g., polycrystalline diamond (PKD), cubic boron nitride (CBN), CVD diamond, cermet or the like. The use of such a cutting insert with drilling tools is known in the art. However, the receiving pocket can be correspondingly configured so as to make it especially easy to situate the cutting insert essentially flush with the plane surface of the cut-in, or with a defined (slight) excess length relative to the plane surface.

Regardless of whether the drilling tool is designed as a single piece or fitted with one or more plate-like cutting inserts, the plane surface, provided the cut-in forms a plane surface, lies at a defined angle relative to the tool axis that is preferably less than or equal to the front rake angle or twist angle of the flute. The plane surface leads to a linearly running main cutting edge. Another advantage lies in the fact that the plane surface makes it especially easy to align the main cutting edge, e.g., radially. The angular difference between the plane surface angle and front rake angle or twist angle of the flute relative to the tool axis also imparts a twist to the chip being discharged in the flute during the transition from the plane surface to the flute surface, which is conducive in breaking up the chip.

The receiving pocket is preferably adjusted to the geometry of the plate-like cutting insert in such a way that the cutting insert in the receiving pocket can be arranged is essentially flush with the plane surface of the cut-in, or with a defined excess length relative to the plane surface of the cut-in.

The drilling tool according to the invention can be single- or multiple-edged, with one or more flutes running linearly, for example axially parallel, or helically around the tool axis. In a preferred embodiment, the drilling tool according to the invention has a two-edged point geometry with a point symmetrical edge arrangement and point thinned chisel edge. A point geometry with point thinned chisel edge is known in the art. However, the drilling tool according to the invention combines the known advantages arising from the chisel edge point thinning with the aforementioned advantages of a cut-in in the chip-forming zone.

In order to [prevent chinking of] the edge formed between the point thinning and adjacent main free surface of the leading web in the rotational direction, it can be removed or abraded.

### BRIEF DESCRIPTION OF THE DRAWINGS

Based on the drawings, a preferred embodiment and various modifications of the drilling tool according to the invention will be depicted below.

FIG. 1 presents a side view of the drilling tool according to the invention in the preferred embodiment.

FIG. 2 presents a cutting element tip segment of the drilling tool according to the invention from FIG. 1.

FIG. 3 presents the cutting element tip segment according to FIG. 2 with a plane surface highlighted by hatched lines.

FIG. 4 presents a schematic view of the concept underlying the cut-in according to the invention.

FIGS. 5 to 9 present cutting element tip segments of modified drilling tools.

### DETAILED DESCRIPTION OF THE INVENTION

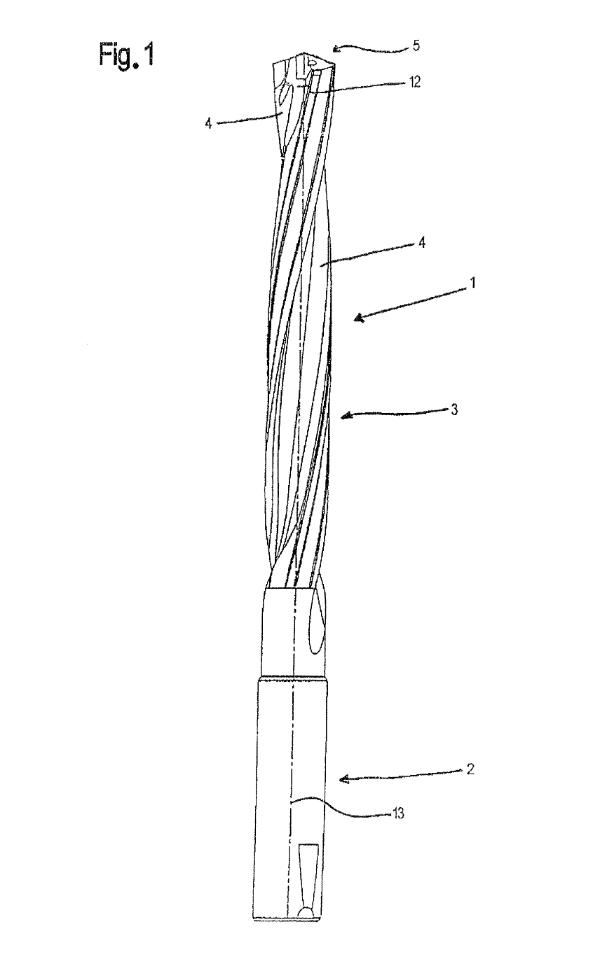

In the embodiment presented on FIG. 1, the drilling tool 1 is configured as a two-edged spiral drill. The drilling tool depicted on FIG. 1 can be functionally divided into a clamping shaft 2 for clamping the drilling tool 1 in a tool holder (not shown), e.g., a jaw chuck, and a cutting element 3 contiguous with the clamping shaft 2. The cutting element 3 has two flutes 4 that run helically around the tool axis, and each are distinguished by a flute surface with a concavely curved cross section, as well as a cutting element tip 5 provided with a point thinning.

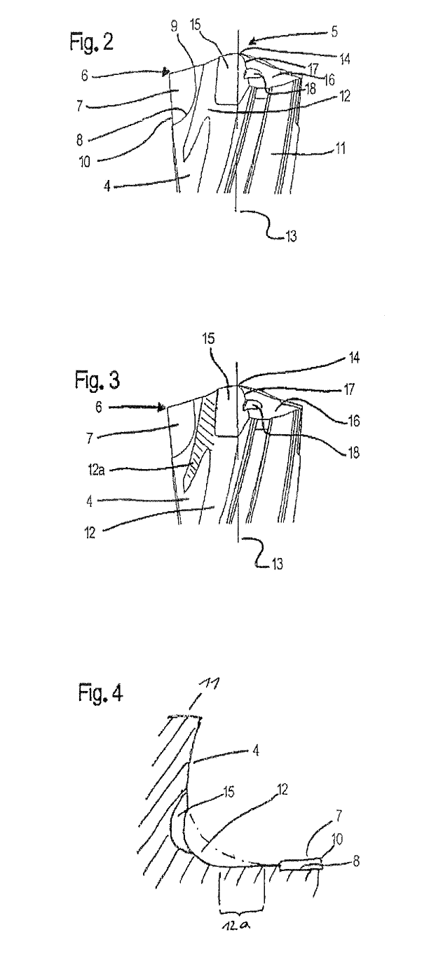

In the drilling tool 1 shown on FIG. 1, the cutting element 3 consists of a base body, which in the area of the noses 6 (see FIG. 2) is fitted with a respective plate-like cutting insert 7. The cutting inserts 7 are each situated in a frontally and circumferentially open receiving pocket 8 worked into the area of the nose 6 of the corresponding flute. As a result, the cutting inserts 7 each help to form the main and secondary cutting edges 9, 10 in the area of the nose 6. The plate-like cutting inserts 7 are made out of a highly wear resistant material, e.g., polycrystalline diamond (PKD), cubic boron nitride (CBN), CVD diamond, cermet or the like.

According to the invention, the two flutes 4 in the drilling tool shown on FIG. 1 are each ground into the chip-forming zone adjacent to the main cutting edge 9, in particular in such a way that the cut-in encompasses the flute front, i.e., the cutting face, and the back segments of the web 11 leading in the rotational direction. The cut-in 12 can be relatively easily actuated by means of a suitable form grinding wheel dipped into the respective flute 4 from the side and then guided in the direction of the cutting element tip 5, and enlarges the cross section of the flute 4 in the area of the chip-forming zone. As a result, the chip formed at the main cutting edge 9 has available to it in the area of the chip-forming zone a chip space with an enlarged cross section, in which the chips can be discharged in the direction of the clamping shaft 2. In addition, the cut-in 12 yields a surface area that encompasses the flute front and back segment, and has a more strongly curved cross section than the cross section of the flute 4 outside the cut-in 12.

FIG. 4 presents a schematic view of the cut-in 12 in the flute 4. The dot-dashed line denotes the cross section of the flute 4 without or in a section that has been cut into. As evident, the cut-in 12 increases the cross section of the flute 4. In addition, a chip guiding stage 16 is formed via the cut-in 12 with a more strongly curved cross section. As a consequence, the chip in the area of the cut-in 12 becomes more strongly curved than in the area of the flute 4 outside the cut-in 12. The stronger chip curvature helps cause the chip to break up relatively early, so that short chip fragments are present at the outlet of the cut-in 12 or chip-forming zone, which then can be smoothly discharged via the area of the flute 4 contiguous with the cut-in 12.

As evident from FIG. 2, the cut is introduced into the flutes 4 in particular in such a way that the cut-in 12 extends only over a relatively short axial length of the cutting element 3. For example, the axial length over which the cut-in 12 extends measures 0.5 to 1.5 times the tool diameter. As a result, the core cross section of the drilling tool can be retained over an essentially axial length despite the cut-ins 12 in the flutes 4, making it possible to ensure a long tool service life.

In the drilling tool 1 depicted on FIG. 1, a respective plane surface 12a is formed by the cut-in 12 in the respective flute 4, which basically exhibits a flute surface with a concavely curved cross section. One of the plane surfaces 12a is denoted by hatched lines on FIG. 3. The plane surfaces 12a are each aligned at a defined angle relative to the tool axis 13, which is preferably less than or equal to the front rake angle or twist angle of the flute 4.

Even though the plane surfaces 12 in the drilling tool 1 shown on FIG. 1 do not extend all the way to the respective plate-like cutting insert 7, the plane surfaces 12a still make it possible to adjust or approximate the level of the flute front surface to the level of the surface of the chip surface formed in the cutting insert 7, at least in the area of the chip-forming zone. This makes a flute cross section enlarged by the cut-in 12 available to the chips formed at the main cutting edges 9.

The cut-in 12 extending frontally beyond the cutting element tip 5 corrects the position and progression of the main cutting edge 9 in such a way that the main cutting edges 9 formed by the cutting inserts 7 and tool base body in the drilling tool shown on FIG. 1 each lie essentially in an axial plane of the drilling tool 1.

In the drilling tool 1 according to the invention, the cut-ins 12 each lie radially inside the nose 6 between the main and secondary cutting edge 9, 10. In addition, the cut-ins 12 run in front of the respective secondary cutting edge 8, which in the drilling tool 1 shown on FIG. 1 is formed by the cutting inserts 7 and the tool base body.

As evident from FIG. 2, the drilling tool 1 depicted on FIG. 1 has a two-edged point geometry with a point symmetrical edge arrangement and point thinned chisel edge 14. A point geometry with point thinned chisel edge is known in the art. However, the drilling tool 1 according to the invention combines the known advantages arising from the chisel edge point thinning 15 with the aforementioned advantages of the cut-in 12 of the chip-forming zone. As a consequence, the cut-ins 12 according to the invention represent additional structural measures independent of the chisel edge point thinning 15 that positively impact chip discharge in the area of the chip-forming zone. In order to lengthen the tool service life or prevent any chinking of the edges 17 that form between the point thinning 12 and adjacent main free surface 16 of the respective web 11 leading in the rotational direction, these edges 17 are preferably removed or abraded.

In order to improve the discharge of chips or chip fragments, the drilling tool 1 depicted on FIG. 1 is also provided in a known manner with an internal coolant/lubricant supply system with outlet openings 18 that open frontally.

In partially a perspective view, FIGS. 4 to 9 show modified cutting element tip segments of a drilling tool fitted with cutting inserts 7.

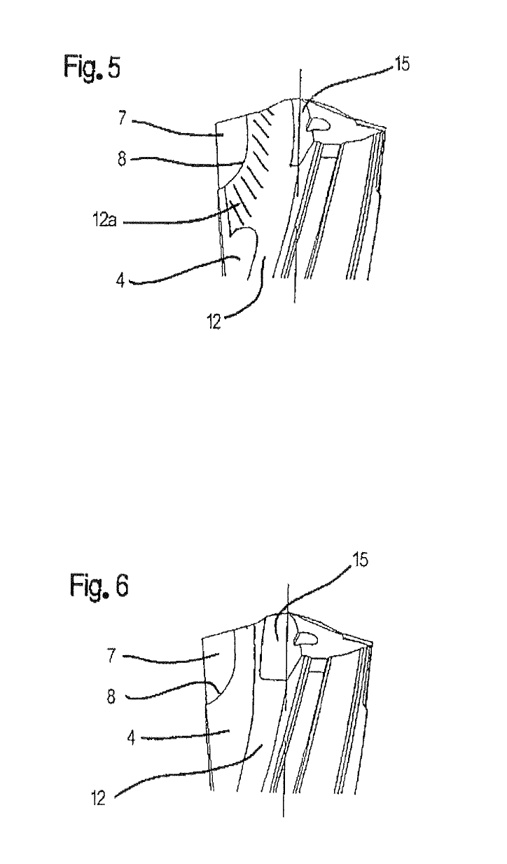

While the cut-in 12 is respectively designed in such a way in the drilling tool 1 shown on FIGS. 1 to 3 as to not encompass the receiving pocket of the cutting insert 7, the cut-in 12 can also be expanded up until the area of the receiving pocket 8 for the cutting insert 7 as viewed in a radial direction. FIG. 5 shows an example of a cutting element tip 5 modified in such a way. In this case in particular, the receiving pocket 8 is configured in such a way that the cutting insert 7 as viewed in the rotational direction of the drilling tool 1 is either situated flush with the plane surface 12a formed by the cut-in, or has a defined, slight excess length relative to the plane surface 12a formed by the cut-in.

In the modification shown on FIG. 6, the cut-in 12 is concentrated more on the back segment than the flute front.

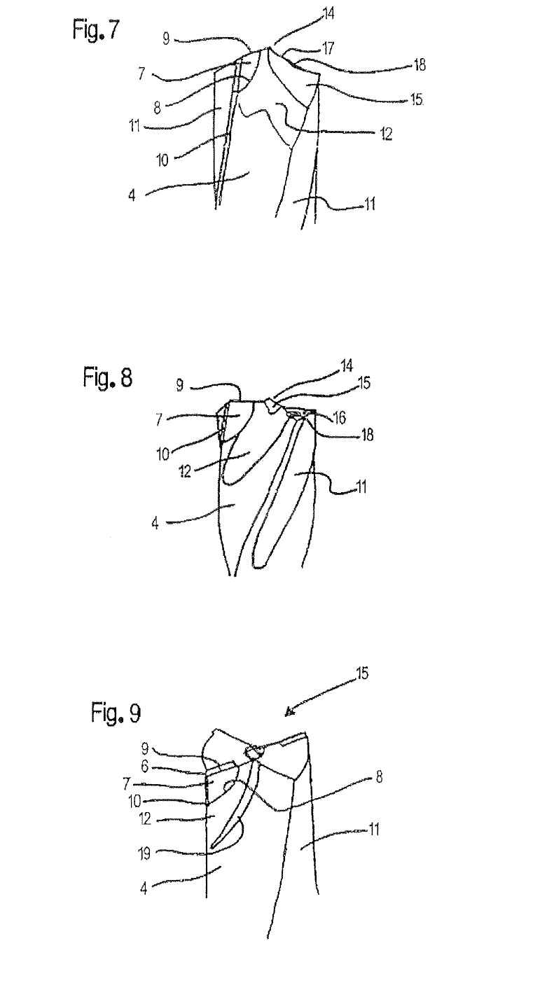

FIG. 7 presents a modification in which the cut-in 12 extends over a large surface of the flute front and back segment in the chip-forming zone. In this modification, the chisel edge point thinning 15 extends from the cutting element tip up to the outer circumference of the drilling tool 1. Not visible in the perspective view is the main free surface, which lies in front of the surface of the point thinning 15 viewed in the rotational direction. The edge 17 formed between the point thinning surface and the no longer visible main free surface is removed in the area of the outlet opening 18 of the interior coolant/lubricant supply system and the cutting element tip 14.

FIG. 8 presents a modification in which the cut-in 12 is concentrated on a transitional area between the flute front and back segment. Clearly evident here is the chisel edge point thinning 15 and main free surface 16.

In the modification shown on FIG. 9, the cut-in 12 is clearly discernible as a plane surface that encompasses the nose 6, which incorporates the receiving pocket 8 for the cutting insert 7. The cut-in 12 forms a chip guiding stage 19 at the transition to the flute 4.

Of course, other modifications are possible.

As an alternative to the drilling tools described above, for example, the drilling tool according to the invention can exhibit a one-piece design and consist of a suitable material, e.g., solid carbide. In this case, the flutes can be cut in so that the cut-ins significantly define the noses, and hence the main and secondary cutting edges.

As an alternative to the two-edged drilling tool described above, the drilling tool according to the invention can exhibit a single-edged design, or exhibit more than two edges.

As an alternative to the helically fluted drilling tools described, above, the flutes can also be straight.

In addition, let it be noted that, according to the invention, the features of the drilling tools described above can be combined with each other as desired within the bounds of the technically realizable, as well as within the scope of the claims.

1. A drilling tool with a clamping shaft and a cutting clement contiguous with the clamping shaft, which exhibits at least one flute with a flute surface having a concave cross section,
the at least one flute in the chip-forming zone adjacent to the main cutting edge cut into the area of the flute front and/or back segment to enlarge the flute cross section.

2. The drilling tool according to claim 1, wherein the cut-in lies radially inside the nose, which is formed by the main and secondary cutting edges allocated to the at least one flute.

3. The drilling tool according to claim 1, wherein the cut-in encompasses the nose, which is formed by the main and secondary cutting edges allocated to the at least one flute.

4. The drilling tool according to claim 1, wherein the cut-in gradually runs out radially inside the secondary cutting edge allocated to the at least one flute.

5. The drilling tool according to claim 1, wherein the drilling tool further comprises a plate-like cutting insert that sits in a receiving pocket worked into the flute.

6. The drilling tool according to claim 5, wherein the receiving pocket is designed in such a way that the plate-like cutting insert forms the nose.

7. The drilling tool according to claim 5, wherein the cut-in defines a plane surface, and the receiving pocket is designed in such a way as a function of the geometry of the plate-like cutting insert that the cutting insert can be situated essentially flush with the plane surface, or with a defined excess length projecting over the plane surface.

8. The drilling tool according to claim 1, wherein the cut-in forms a plane surface, which is arranged at a defined angle relative to the tool axis.

9. The drilling tool according to claim 8, wherein the plane surface at least partially forms the main cutting edge.

10. The drilling tool according to claim 8, wherein the angle of the plane surface relative to the tool axis is less than or equal to the front rake angle or twist angle of the flute.

11. The drilling tool according to claim 1, wherein the drilling tool further comprises a two-edged point geometry with point symmetrical edge arrangement and point thinned chisel edge.

12. The drilling tool according to claim 11, wherein the edge formed between the chiseled edge point thinning and adjacent main free surface is removed for stabilization purposes.
